(19) United States
(12) Patent Application Publication
(10) Pub. No.: US 2022/0345564 A1
(43) Pub. Date: Oct. 27, 2022

(54) PORTABLE CONTROL APPARATUS FOR CONTROLLING A MOTION SENSOR

(71) Applicant: STEINEL GMBH, Herzebrock-Clarholz (DE)

(72) Inventor: Thomas Möller, Herford (DE)

(73) Assignee: STEINEL GMBH, Herzebrock-Clarholz (DE)

(21) Appl. No.: 17/763,393

(22) PCT Filed: Sep. 17, 2020
(86) PCT No.: PCT/EP2020/076051

§ 371 Date: Mar. 24, 2022

(30) Foreign Application Priority Data
Oct. 1, 2019 (DE) 10 2019 126 496.0

(51) Int. Cl. H04M 1/72412; G06F 3/0488; G01S 13/58

(52) U.S. Cl. CPC H04M 1/72412; G06F 3/0488; G01S 13/58; H04M 2250/12

(57) ABSTRACT

A portable control apparatus (100) for controlling a motion sensor (200), comprising communication means (110), display means (120) and input means (130). The communication means (110) allow wireless communication with a motion sensor (200) and are suitable for receiving a detection signal, currently generated in the motion sensor (200), from the motion sensor (200) while the control apparatus (100) is in a detection region (210) of the motion sensor (200). The display means (120) allow this detection signal to be displayed. The input means (130) allow the adjustment of a detection threshold at which a movement is detected by the motion sensor (200), on the basis of the displayed detection signal. The adjusted detection threshold is transferred to the motion sensor (200) by the communication means (110) and set there as the applicable detection threshold.

### BACKGROUND OF THE INVENTION

The present invention relates to portable control apparatuses for controlling motion detectors, and methods for controlling motion detectors by means of portable control apparatuses.

Various technologies are available for the detection of motion by means of motion detectors. For example, motion can be detected, amongst others, by means of infrared radiation, radar waves, ultrasound or also based on camera images. To avoid unwanted motion detection, it is always necessary to make adjustments to the motion sensors. In addition to the obviously necessary adjustment of the visual or detection range of the motion sensors, however, it can be possible or necessary to adjust additional operating parameters. In particular, the adjustability of the range of motion detection, i.e., the maximum distance up to which motion is to be detected, is of interest here, but usually difficult to achieve.

Thus, it is usually necessary to infer the resulting “sensor range” from the measured values of the various types of motion detectors. For example, a radar sensor has no fixed range. A distinction between motion detection in the immediate environment and non-motion detection at a further distance is made by setting a threshold value for the intensity of the received backscattered radar waves detected by the sensor. A low threshold value corresponds to the possibility of detecting motion even at greater distances, while a high threshold value restricts motion detection to the sensor's close range.

In order to adjust the range of a radar sensor, it has been necessary up to now to adjust a certain threshold value on the sensor and then to check whether the threshold value corresponds to the desired range by making a movement within the detection range of the sensor. If this is not the case, the threshold value must again be adjusted on the sensor and the result checked again at a corresponding distance from the sensor. These steps continue until a satisfactory result for the sensor range has been found.

Similarly, other sensor types can also require adjustment and checking operations until a desired sensor range is found, since the sensor measured values cannot be directly converted into a range scale.

This results in a considerable loss of time during the installation and maintenance of motion sensors, especially in larger systems where a large number of motion detectors are installed, such as in hotels, underground garages or the like. Even a trained technician will have to adjust and check the sensor at least twice on average to adjust the range. If one assumes 10 minutes for one adjustment and checking cycle (climbing up to the sensor, which is usually installed near the ceiling, adjusting the threshold value, positioning within the detection range, checking the range), this results in a time expenditure of 200 minutes, i.e., approx. three and a half hours, for a system with 10 motion sensors. The current adjustment of range of motion detectors is therefore extremely time-consuming and thus cost-intensive.

### SUMMARY OF THE INVENTION

It is therefore an object of the invention to specify a control apparatus for motion sensors with which a control corresponding to the adjustment of range can be carried out, which is reliable, quick and easy to perform. This object is achieved with the subject matter of the independent claims.

For example, a portable control apparatus for controlling a motion sensor can include communication means, display means, and input means. The communication means serve to wirelessly communicate with a motion sensor and are suitable for receiving a detection signal momentarily generated in the motion sensor from the motion sensor, while the control apparatus is located within a detection range of the motion sensor. The display means serve to display this detection signal. The input means serve to adjust a detection threshold value at which motion is detected by the motion sensor, based on the displayed detection signal. In this process, the adjusted detection threshold value is transmitted to the motion sensor by the communication means, and is set there as the valid detection threshold value.

Thus, a portable control apparatus is used to adjust the detection threshold value, which allows the detection threshold value to be changed within the detection range of the motion sensor. For this purpose, the control apparatus is equipped with communication means, such as a radio antenna or a Bluetooth interface. While an operator of the control apparatus moves with it within the detection range of the motion sensor, a detection signal corresponding to the motion is generated by the motion sensor and communicated to the control apparatus via the communication means.

The detection signal is then depicted on the display means of the control apparatus, which can be a screen. In this process, the detection signal can be stored in a memory of the control apparatus.

The communication means and display means thus allow an operator of the control apparatus to view the signal actually detected by the motion detector while performing the movements that generate the signal. This enables the operator to immediately understand how their momentarily executed movements affect the motion detection. Thus, it is not necessary to determine this by adjusting threshold values on the motion detector and the subsequent checking of the adjustments within the detection range. Rather, a single glance at the display means of the carried control apparatus is sufficient to understand the effects of the momentarily executed movements on the motion detector.

The detection threshold value can then easily be entered directly into the control apparatus using the input means and transmitted to the motion detector. In particular, the detection threshold value can be adjusted to the value of the detection signal caused by the momentary motion. Since typically a motion occurring closer to the sensor generates a stronger detection signal than a motion occurring further away from the sensor, this corresponds to adjustment of the detection threshold value to a range of the sensor corresponding to the position of the operator.

It is therefore possible to adjust the range of the motion sensor in a simple manner. All that is necessary for this is to establish communication between the control apparatus and the motion sensor and to signal the resetting of the detection threshold value to move in front of the motion sensor at the desired distance, and to adjust the detection threshold value according to the detection signal displayed at that moment. This saves much of the time previously required for sensor adjustment. In addition, the adjustment of the range becomes more reliable due to the direct comparison between the detection signal and the detection threshold value that is now possible.

In this process, the display means and the input means can be configured in combination as a touch screen. In this case, the control apparatus can thus be implemented by means of a smartphone or a tablet, for example, on which the program or applications (apps) required for the functionalities described above are stored or run. This makes it possible to use any smartphone or the like as a control apparatus if a communication interface with the motion sensors is available, e.g., via Bluetooth, W-LAN or NFC. Acquisition costs for additional control apparatuses can thus be eliminated.

Alternatively, however, the input means can also be provided separately from the display means. For example, input can also be made via rotary knobs, sliders or a keyboard attached to or connected to the control apparatus, such as with a laptop. This can be advantageous if special functions are to be implemented that cannot be achieved with a smartphone or the like, such as increased impact resistance. It is also possible to design the display means not as a screen but, for example, in the form of several luminous displays which, for example, reproduce five levels for the detection signal strength by means of five different lights. The threshold value could then also be set to five levels accordingly, e.g., by operating pushbuttons, rotary heads or sliders.

As another alternative, the signal exchange between the motion sensor and the control apparatus can also be largely automatic. In this case, the only input required on the control apparatus is to start the adjustment of the range. The motion sensor then measures the detection signal and automatically adjusts the detection threshold value to the measured detection signal. The detection signal is then “displayed” to the control apparatus only to the extent that it is apparent from the control apparatus that an adjustment of the detection threshold value has been started or is being made. Also in this way, the range of the motion sensor can be adjusted in a simple manner.

The display means can be suitable for displaying the adjusted detection threshold value in addition to the detection signal. This offers a particularly intuitive and thus time-saving adjustability of the range due to the simple operability.

The display means can be suitable for displaying an intensity of the detection signal momentarily generated in the motion detector, and the input means can be suitable for adjusting the detection threshold value to an intensity value.

Thus, the intensity of the received detection signal is sent from the motion sensor to the control apparatus. In the case of a radar sensor, this can be the detected intensity of radar waves emitted by the sensor and backscattered by a moving object, or variables derived therefrom such as a Doppler signal. In an IR sensor, the intensity of infrared radiation emitted by an object can be measured. In general, the intensity displayed can be used for any type of sensor that operates based on measurements of radiation or waves reflected or emitted by a moving object. For example, ultrasonic sensors or the like can also be used.

The intensity of the signal measured by the motion sensor can be compared to a detection threshold value in a simple manner. If the intensity is higher than a threshold value set based on motion at a specific distance, it can be assumed that the corresponding motion is occurring at a distance from the sensor that is less than the specific distance. Thus, an operator can easily make an adjustment of range based on the intensity. Since typically for the common types of sensors (radar, IR, ultrasonic sensors and the like) the signal generated by adult humans depends little on the specific body shape, it is thus possible to reliably make an adjustment of range that is correct to a first approximation not only for the specific (adult) operator of the control apparatus, but for all adult humans.

In this process, the intensity can be displayed on a scale between minimum intensity and maximum intensity, and the intensity threshold value can be set with respect to the same scale. Thus, a scale is given as a visual feedback that displays which intensity causes a momentarily executed motion of an operator of the control apparatus. At the same time, the operator can easily enter the detection threshold value into this scale, e.g., by means of a touch screen directly within the scale, by means of a keyboard input, or also by means of push buttons or rotary knobs. This enables the detection threshold value to be set precisely and thus the range to be adjusted precisely. In addition, an experienced operator can infer the intensity at other distances from the intensity displayed on the scale for a particular distance and adjust the detection threshold value to this intensity estimated based on the scale. This allows the range of motion sensors to be adjusted even more flexibly and thus in a more time-saving manner.

The display means can be suitable for displaying additional operating parameters of the motion sensor or of an electrical device controlled by the motion sensor, the input means can be suitable for receiving adjustments of the additional operating parameters, and the communication means can be suitable for transmitting the received adjustments of the additional operating parameters to the motion sensor. As a result, additional operating parameters of the motion sensor can be monitored and adjusted, such as an activation period, a transmission frequency, an interface selection, and the like. Moreover, in apparatuses in which the motion sensor is integrated into or connected to the device controlled by the motion sensor, such as lights, elevators, windows, doors (e.g., garage doors or department store doors) or the like, the operating parameters of these devices can also be transmitted to the control apparatus, displayed there, and adjusted from there. For example, the activation period or brightness of a light after motion detection or a delay time between motion detection and activation of a motor for the elevator or door control can be adjusted via the control apparatus.

The communication means can be configured to communicate by means of radio. In particular, the communication means can be configured as a Bluetooth interface that communicates with a Bluetooth interface of the motion sensor. However, the radio connection can also take place via WLAN or the like.

Communication via infrared interfaces is also possible. This allows data to be transmitted between the motion sensor and the control apparatus even over further distances.

A computer program product, when run on a portable apparatus comprising display means, input means and communication means, can cause the apparatus to function as a control apparatus as described above. Thus, any device having the appropriate technical components, such as a smartphone, a tablet, a smartwatch or a laptop, can be used as a control apparatus as described above by means of a suitable program or application or app.

A motion detection system can comprise a control apparatus as described above and a motion sensor, for which at least one detection threshold value of its operating parameters is adjustable by the control apparatus. In this way, the range of motion sensors in a motion detection system can be adjusted in a simple and reliable manner.

A method of controlling a motion sensor by means of a control apparatus as described above comprises: Detecting a motion of an operator of the control apparatus within a detection range of the motion sensor by the motion sensor; receiving and displaying the detection signal generated by the motion sensor due to the motion of the operator by the control apparatus; adjusting the detection threshold value to the displayed detection signal with the control apparatus to adjust a range of the motion sensor to the position of the operator; transmitting the adjusted detection threshold value to the motion sensor, and setting the adjusted detection threshold value as the valid detection threshold value of the motion sensor. By these methods, an operator of the control apparatus is enabled in a simple manner to adjust the detection threshold value of a motion sensor such that, after setting the detection threshold value, the sensor has a detection range that corresponds to the distance of the operator from the motion sensor.

### BRIEF DESCRIPTION OF THE DRAWINGS

The present invention is to be described in more detail below with reference to the figures. However, this description is to be understood as purely exemplary. The present invention is defined by the subject matter of the claims.

FIG. 1 shows a schematic representation of a control apparatus in use;

FIG. 2 shows a schematic representation of a possible embodiment of a control apparatus; and

FIG. 3 shows a schematic flowchart of a method of using a control apparatus.

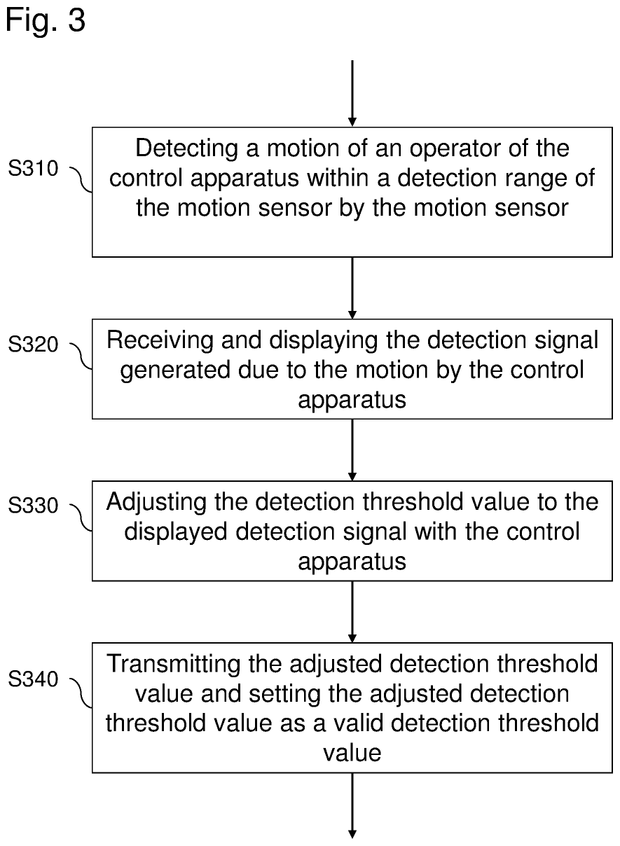

### DETAILED DESCRIPTION

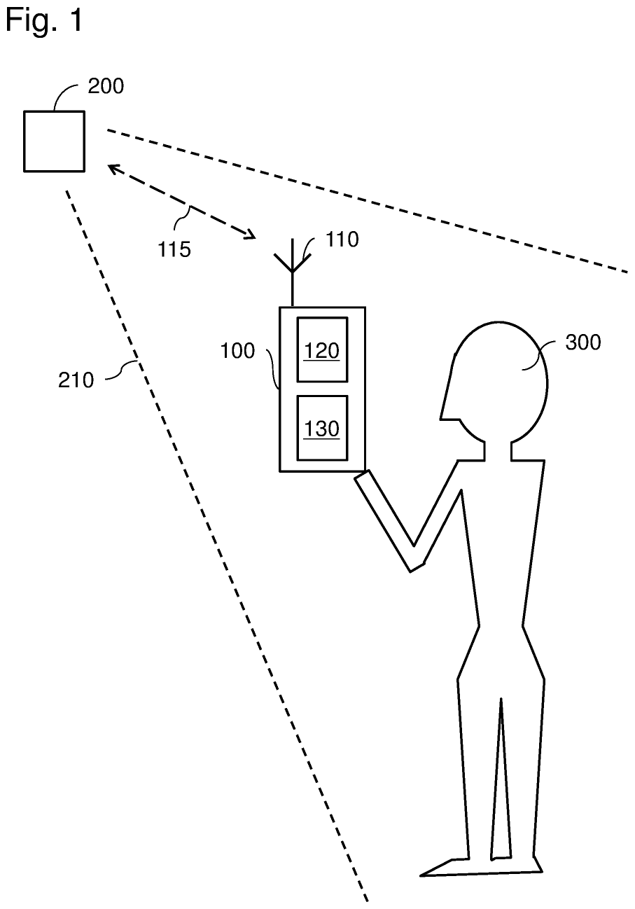

FIG. 1 schematically shows the use of a control apparatus 100 to control a motion sensor 200 by an operator 300.

In this process, the motion sensor 200 can detect motion in a detection or viewing area 210 defined by the design of the sensor. In principle, the motion sensor 200 can use any and all detection methods known from the prior art for this purpose. For example, the motion sensor 200 can measure infrared radiation emitted or reflected by an object within the detection range 210 when the motion sensor 200 itself emits infrared radiation. Similarly, the motion sensor 200 can be configured as an ultrasonic sensor the measurements of which are based on the detection of reflected sound waves. Essentially, any sensor capable of registering motion within the detection range 210 based on, e.g., detected radiation or detected waves can be used.

In the following text, it should be assumed that the motion sensor 200 emits radar waves and detects motion based on the reflected radar waves. Such motion sensors 200 are known from the prior art. A detailed description can therefore be omitted at this point.

The operator 300 is located within the detection range 210 with the portable control apparatus 100 to perform an adjustment of range (and/or other adjustments) of the motion sensor 200. For this purpose, the operator 300, after starting the setting of the range, e.g., by starting a program stored on the control apparatus 100, moves at a distance selected by the operator relative to the motion sensor 200. This motion is detected by the motion sensor 200 and converted into a detection signal. For example, the motion sensor 200 can detect a radar wave backscattered by the operator 300 and determine its amplitude, frequency and phase. Motion can be inferred from the measured signal. The signal can be detected more clearly the closer the operator is positioned to the motion sensor 200.

The detection signal determined by the motion sensor 200 is communicated to the control apparatus 100 via a communication connection 115. For this purpose, the control apparatus 100 includes communication means 110 that are suitable for exchanging data with corresponding communication means in the motion sensor 200. The communication means 110 can provide a radio interface or an infrared interface known per se. For example, communication can take place by means of Bluetooth or WLAN.

The detection signal generated by the motion of the operator 300 is displayed thereon by display means 120 of the control apparatus 100. The operator 300 thus receives immediate, quasi instantaneous feedback as to how their momentarily executed movements are perceived by the motion sensor 200. This allows the operator 300 to understand in a simple manner whether the distance taken for the executed movements results in a desired detection signal in the motion sensor 200.

In this process, the display means 120 can be configured as a screen, such as an LCD screen or the like, on which a display corresponding to the detection signal is displayed. However, the display means 120 can also be of a significantly simpler design, e.g., as a variety of lights, each representing a particular strength of the detection signal, or as a simple display panel for numerical displays, with the strength or intensity of the detection signal being represented by a numerical display, e.g., from 0 to 100. The only decisive factor here is that the operator 300 is given feedback by the motion sensor 200 about the detection signal that is momentarily present.

Indeed, this allows the operator 300 to adjust, namely by means of input means 130 of the control apparatus 100, a detection threshold value of the motion sensor 200 that determines whether or not a measured detection signal triggers an event (e.g., light on, motor on/off, or the like) in a device controlled by the motion sensor 200. For example, the detection threshold can, e.g., indicate the intensity of the signal measured by the motion sensor which triggers the event.

The input means 130 can, in this case, be configured as a touch screen together with the display means 120. This is particularly intuitive, since the detection signal can be displayed and the detection threshold value can be input via a single interface. In particular, it is possible to display the adjusted detection threshold value superimposed on the detection signal on the touch screen and also to be able to change it there. Alternatively, however, the input can also be made via any other type of input interface, e.g., via a keyboard, via pushbuttons, or rotary or slider controls. The only relevant aspect is the fact that the detection threshold value can be adjusted in consideration of the momentarily output detection signal.

Thus, the operator 300 can input a detection threshold value by means of the input means 120 of the control apparatus 100, which is then transmitted to the motion sensor 200 by means of the communication means 110. There, the detection threshold value is set as the newly valid detection threshold value, e.g., by default or based on a corresponding command in the signal from the control apparatus 100 to the motion sensor 200. Thus, the threshold for triggering events by means of the motion sensor 200 can be made in a simple manner by the operator 300 standing remotely from the motion sensor 200.

In this process, the detection threshold value can be adjusted according to the displayed detection signal. This allows an operator 300 to use their own positioning within the detection range 300 to make an adjustment of range for the motion sensor 200. In the simplest case, the detection threshold value is set to the momentarily displayed magnitude of the detection signal. Then, to a first approximation, the range of the motion sensor 200 corresponds to the distance from the operator 300 to the motion sensor 200.

However, the operator 300 can also freely select the detection threshold value based on the displayed detection signal to adjust a distance from the motion sensor 200 deviating from their momentary position as the range based on their experience.

In this way, adjustment of the range of motion sensors 200 is extremely simplified. Instead of having to adjust the sensitivity of the motion sensor 200 directly on the sensor in multiple steps with intermediate check of the sensor response, the adjustment of range can be performed directly within the detection range 210 in a simple, time-saving and convenient manner. In addition, the display of the detection signal allows a more reliable adjustment of the sensor range, since the setting of the detection threshold value is not done by trial and error, but based on the actual values measured by the sensor. A laborious “scanning” of the detection range with a portable controller is therefore not required. Rather, an adjustment of range that is correct to a first approximation can be performed at first glance in a single step.

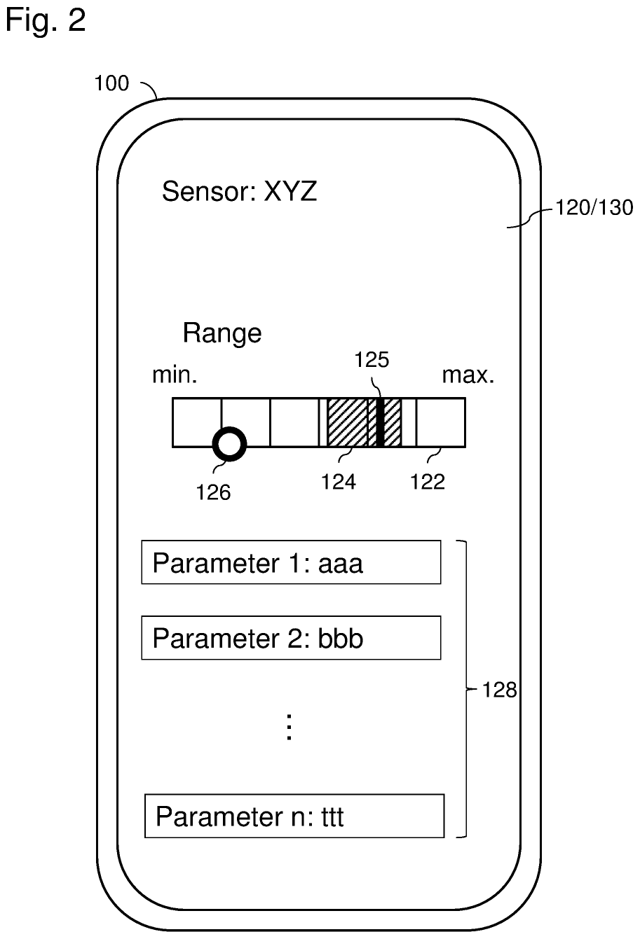

An example of an embodiment of the control apparatus 100 is shown in FIG. 2. There, the control apparatus 100 is configured as a smartphone that has a touch screen as a combined display means 120 and input means 130. Similarly, a tablet or smartwatch can also be configured as a control apparatus. The smartphone constituting the control apparatus 100 includes the usual communication means 110, such as radio antennas for mobile communications, for connection to WLAN, a Bluetooth interface, an infrared interface, an NFC interface and the like. Thus, the smartphone can communicate with any motion sensor 200 that has a corresponding interface.

The functionalities of the control apparatus 100 described above are implemented on the smartphone by means of an application or app, i.e., a computer program. The smartphone has all the components necessary and known from the prior art for this purpose, such as processors, memory and the like. By running the app, the smartphone can act as a control apparatus 100.

By means of the app, the smartphone is able to display any and all motion sensors that are within its range and select them for control. FIG. 2 shows a display after selecting the sensor “XYZ”. Once the sensor is selected, any adjustment of the detection threshold value in the app can result in a reset of the detection threshold value in the selected motion sensor 200. However, it can also be necessary to actively set a new detection threshold value in the app by actuating a corresponding field.

As an indicator of the range of this motion sensor, a scale 122 is shown in the example of FIG. 2, on which the intensity of the detection signal is reflected. There, the scale 122 ranges from minimum to maximum intensity, but can also refer to any range of intensity. In the scale 122, the range of variation 124 of the momentarily measured intensity is shown as a shaded area. In addition, the momentary intensity 125 is shown as a black bar. Thus, an operator of the control apparatus 100 recognizes at first glance to which range of intensity of the sensor signal movements performed by the operator lead. It goes without saying that the specific representation of the scale 122 and the displayed intensity 124, 125 in FIG. 2 is purely exemplary. Any other corresponding form of representation is also possible.

The displayed intensity 124, 125 depends on the distance of the operator 300 from the motion sensor 200. The closer the operator 300 is to the motion sensor 200, the closer to the maximum value the displayed intensity 124, 125 is. It is therefore possible for the operator 300 to establish a relationship between the range of the motion sensor 200 and the measured detection signal via the display of the detection signal or its intensity and their own position within the detection range 210.

Now, in order to make an adjustment of range, a representation of a slider 126 is superimposed on the representation of the scale 122, the position of which on the scale 122 adjusts the detection threshold value to the intensity corresponding to the position and transmits it to the motion sensor 200. Thus, for example, if the slider 126 is set to the indicated range of intensity 124, 125 by means of a corresponding gesture, this corresponds to the setting of a corresponding intensity threshold value in the motion sensor 200. This can simultaneously be regarded as an adjustment of range, since movements at a greater distance than that at which the detection threshold value was set will produce a lower intensity and thus will not trigger an event. Conversely, movements at a smaller distance will produce a greater intensity and thus trigger an event.

In this way, it is thus possible to be able to adjust the range of a large class of motion sensors, such as radar or RF sensors, in a simple, reliable and time-saving manner by means of a control apparatus 100, which can be configured, for example, as a smartphone.

In addition, further operating parameters of the motion detector 200 can also be changed or adjusted by means of the control apparatus 100. This is represented for the example of FIG. 2 by the fields 128. Such parameters, for example, can be an activation period, a transmission frequency, an interface selection and the like. In addition, the devices controlled by the motion sensor 200, such as lights, elevators, windows, doors (e.g., garage doors or department store doors) or the like, or their operating parameters can be controlled by means of the control apparatus 100.

These operating parameters can be transmitted to the control apparatus 100, displayed thereon, and adjustable from there. For example, the activation period or the brightness of a light following motion detection or a delay time between motion detection and activation of a motor for the elevator or door control can be adjusted via the control apparatus. In the example of FIG. 2, for example, this is done in one of the fields 128, into which corresponding values for the operating parameters can be entered.

Thus, in addition to adjusting the detection threshold value, the control apparatus 100 allows the adjustment of a broad class of operating parameters of the motion detector 200 or electrical devices that it controls.

A method of adjusting a range of a motion sensor by means of a control apparatus as described above includes the following 10 steps:

At S310, a motion of an operator of the control apparatus within a detection range of the motion sensor is detected by the motion sensor. For this purpose, the operator positions themselves at a distance desired by them from the motion sensor while holding the control apparatus in their hand, and performs a typical motion to be detected by the motion sensor.

At S320, the detection signal generated by the motion sensor due to the motion of the operator is sent to, received by, and displayed on the control apparatus. Thus, the operator receives immediate feedback of the detection signal generated by their motion.

At S330, the detection threshold value is adjusted to the displayed detection signal with the control apparatus in order to adjust a range of the motion sensor to the position of the operator. Based on the displayed detection signal, it is thus possible in a particularly simple, intuitive and time-saving manner to adjust the detection threshold value of the motion sensor to a value that corresponds to a limitation of range to the distance of the operator from the motion sensor.

At S340, the adjusted detection threshold value is transmitted to the motion sensor and set there as a valid detection threshold value. This fixes the adjustment of the detection threshold value. The detection threshold value remains at the adjusted value until a new detection threshold value is entered into the control apparatus or the command is issued by means of the control apparatus to repeat steps S310 to S340 in order to set a new detection threshold value.

The apparatuses and methods outlined above thus make it possible to carry out adjustments of range of motion sensors in a simple, reliable and time-saving manner.

1. A portable control apparatus (100) for controlling a motion sensor (200), comprising:
communication means (110) for wirelessly communicating with a motion sensor (200), which are suitable for receiving a detection signal momentarily generated in the motion sensor (200) from the motion sensor (200), while the control apparatus (100) is located within a detection range (210) of the motion sensor (200);
display means (120) for displaying the detection signal; and
input means (130) for adjusting a detection threshold value at which motion is detected by the motion sensor (200), based on the displayed detection signal; wherein
the adjusted detection threshold value is transferred to the motion sensor (200) by the communication means (110) and is set there as a valid detection threshold value.

2. The control apparatus (100) according to claim 1, wherein
the display means (120) and the input means (130) are configured in combination as a touch screen.

3. The control apparatus (100) according to claim 1, wherein
the display means (120) are suitable for displaying the adjusted detection threshold value in addition to the detection signal.

4. The control apparatus (100) according to claim 1, wherein
the display means (120) are suitable for displaying an intensity of the detection signal momentarily generated in the motion detector (200); and
the input means (130) are suitable for adjusting the detection threshold value to an intensity value.

5. The control apparatus (100) according to claim 4, wherein
the intensity is displayed on a scale (122) between minimum intensity and maximum intensity; and
the detection threshold value is adjusted with regard to the same scale.

6. The control apparatus (100) according to claim 1, wherein
the display means (120) are suitable for displaying additional operating parameters of the motion sensor (200) or of an electrical device controlled by the motion sensor (200);
the input means (130) are suitable for receiving adjustments of the additional operating parameters; and
the communication means (110) are suitable for transferring the received adjustments of the additional operating parameters to the motion sensor (200).

7. The control apparatus (100) according to claim 1, wherein
the communication means (110) are configured for communicating by means of radio.

8. A computer program product which, when run on a portable apparatus comprising display means (120), input means (130) and communication means (110), causes the apparatus to function as a control apparatus (100) according to claim 1.

9. A motion detection system, comprising:
a control apparatus (100) according to claim 1; and
a motion sensor (200), for which at least one detection threshold value of its operating parameters is adjustable by the control apparatus (100).

10. A method of controlling a motion sensor (200) by means of a control apparatus (100) according to claim 1, comprising the steps of:
detecting a motion of an operator (300) of the control apparatus (100) within a detection range (210) of the motion sensor (200) by the motion sensor (200);
receiving and displaying the detection signal generated by the motion sensor (200) due to the motion of the operator (300) by the control apparatus (100);
adjusting the detection threshold value to the displayed detection signal with the control apparatus (100) to adjust a range of the motion sensor (200) to the position of the operator (300);
transmitting the adjusted detection threshold value to the motion sensor (200), and setting the adjusted detection threshold value as a valid detection threshold value of the motion sensor (200).
